(19) United States
(12) Patent Application Publication
(10) Pub. No.: US 2018/0247378 A1
(43) Pub. Date: Aug. 30, 2018

(54) Analysis Engine for the Presentation of Complex Data

(71) Applicant: The Bureau of National Affairs, Inc., Arlington, VA (US)

(72) Inventors: Diane Tinney, Alexandria, VA (US); Kenneth B. Crutchfield, Alexandria, VA (US); Rajesh Vantipalli, Ashburn, VA (US); Paul Mulgrew, Sterling, VA (US); Jordan Nowak, Leesburg, VA (US)

(73) Assignee: The Bureau of National Affairs, Inc., Arlington, VA (US)

(21) Appl. No.: 15/443,245

(22) Filed: Feb. 27, 2017

(51) Int. Cl. G06Q 40/00; G06F 17/24

(52) U.S. Cl. CPC G06Q 40/123; G06F 17/245

(57) ABSTRACT

Systems and methods for reducing the complexity of presenting complex data are provided. An analysis engine receives data for performing an analysis and generates results of the analysis. The results include a value of a variable associated with a particular period of time and a plurality of allocated amounts. Each of the plurality of allocated amounts are allocated from the value and associated with a respective other period of time. The analysis engine causes the results of the analysis to be displayed on a display device such that the value is presented as being associated with the particular period of time and each allocated amount is presented as being associated with its respective other period of time.

### TECHNICAL FIELD

The present invention relates generally to the analysis of complex data and more particularly to an improved analysis engine for the presentation of complex analytical results.

### BACKGROUND OF THE INVENTION

Computer systems are often used to perform various data analysis tasks. With the advancement of computer technology, these data analysis tasks have become increasingly complex, thereby resulting in complex analytical results. Conventional computer systems have difficulty presenting these complex analytical results in a manner that is easily understood by the user.

As an example, tax software is traditionally implemented on computer systems to automate the preparation of tax returns. However, traditional tax software is unable to automate the calculation and tracking of certain tax data such as net operating loss. A net operating loss occurs when tax deductible expenses exceed taxable income over a taxable period of time. Depending on the applicable laws and regulations, net operating loss may be utilized to reduce or eliminate taxable income in prior and future taxable periods of time

The calculation and tracking of net operating loss at the state level is complex, as each state has different laws governing how to compute net operating loss in the year of generation and how the calculated net operating loss can be utilized to offset prior or future profitable years. Further compounding this complexity are changes in state income due to the impact of mergers and acquisitions and federal and state tax audits. Such changes in state income and loss results in changes in the carryback and carryforward of net operating loss.

Traditional tax software is not able to successfully automate the calculation and tracking of net operating loss for all states in the United States across multiple years. Conventionally, the calculation and tracking of net operating losses has been performed using spreadsheets or databases. Such conventional approaches have poor controls, require large annual updates for tax law changes, and are often inaccurate. This may result in over or under utilization of the net operating loss, and adds further risk to investors who rely accurate balance sheets, which list the net operating loss as an asset, to make investment decisions. Additionally, auditors have difficulty reviewing these conventional spreadsheets or databases to identify the true value of net operating loss across different entities and jurisdictions. Taxpayers also have difficulty accurately forecasting profits for future years due to the difficulty in predicting the utilization of net operating losses.

### SUMMARY

In accordance with one or more embodiments, an analysis engine is provided for reducing the complexity of presenting complex analytical results. The analysis engine receives data for performing an analysis and generates results of the analysis. The results include a value of a variable associated with (e.g., incurred in) a particular period of time and a plurality of allocated amounts. Each of the plurality of allocated amounts are allocated from the value and associated with (e.g., apportioned or applied to) a respective other period of time. The analysis engine causes the results to be presented on a display device such that the value is presented as being associated with the particular period of time and each allocated amount is presented as being associated with its respective other period of time. Advantageously, the results are presented in a manner which quickly communicates the value of the variable and how the value allocated into the plurality of allocated amounts over the other periods of time.

In accordance with one or more embodiments, the results may also include a plurality of utilized amounts of the variable, each associated with a respective other period of time. Each respective utilized amount represents a sum of all allocated amounts that are associated with a same period of time as the respective utilized amount (i.e., allocated amounts that are associated with a respective other period of time that is the same as the respective other period of time of the utilized amount).

In accordance with one or more embodiments, the analysis engine causes the results to be displayed on a table having rows and columns each corresponding to periods of time (e.g., years). The value of the variable is presented in a cell of the table that is associated with a row and column both corresponding to the particular period of time. Each of the allocated amounts is presented in a respective cell of the table that is associated with a row corresponding to its respective other period of time and a column corresponding to the particular period of time. Each of the utilized amounts is also presented in a respective cell of the table that is associated with a row and a column corresponding to its respective other period of time. In this manner, the utilized amounts are presented in a stair step configuration in the table. While the table is described herein as having data presented in cells associated with rows and columns, one of ordinary skill in the art would understand that the table may be transposed to switch the rows to the columns and vice versa.

In accordance with one or more embodiments, the analysis engine is a tax analysis engine which generates tax results. For example, the tax results may include a value of a tax variable such as a net operating loss associated with the particular period of time. The tax results may also include allocated amounts of net operating loss each associated with a respective other period of time and utilized amounts of the net operating loss each associated with a respective other period of time. The results are presented such that the value of the net operating loss is presented in a cell of a table having a row and a column both associated with the particular period of time, each allocated amount is presented in a respective cell of the table associated with a row corresponding to its respective other period of time and a column corresponding to the particular period of time, and each utilized amount is presented in a respective cell of the table associated with a row and a column both corresponding to its respective other period of time. As such, the tax results are displayed in a manner that quickly communicates the value of the net operating loss, how the net operating loss is allocated over the other periods of time, how net operating loss is utilized over the other periods of time, the amount of remaining net operating loss available to be utilized in the future, and the expiration of the remaining net operating loss.

These and other advantages of the invention will be apparent to those of ordinary skill in the art by reference to the following detailed description and the accompanying drawings.

### BRIEF DESCRIPTION OF THE DRAWINGS

FIG. 1 shows a high-level diagram of a communications system, in accordance with one embodiment;

FIG. 2 shows a system architecture for the presentation of results of data analysis, in accordance with one embodiment;

FIG. 3 shows an exemplary presentation of results of data analysis, in accordance with one embodiment;

FIG. 4 shows another exemplary presentation of results of data analysis, in accordance with one embodiment;

FIG. 5 shows an exemplary presentation of tax results, in accordance with one embodiment;

FIG. 6 shows an exemplary presentation of tax results including a utilization schedule of the net operating loss, in accordance with one embodiment;

FIG. 7 shows another exemplary utilization schedule of the net operating loss, in accordance with one embodiment;

FIG. 8 illustratively depicts a flow diagram of a method for operating an analysis engine, in accordance with one embodiment; and

FIG. 9 shows a high-level block diagram of a computer for an analysis engine, in accordance with one embodiment.

### DETAILED DESCRIPTION

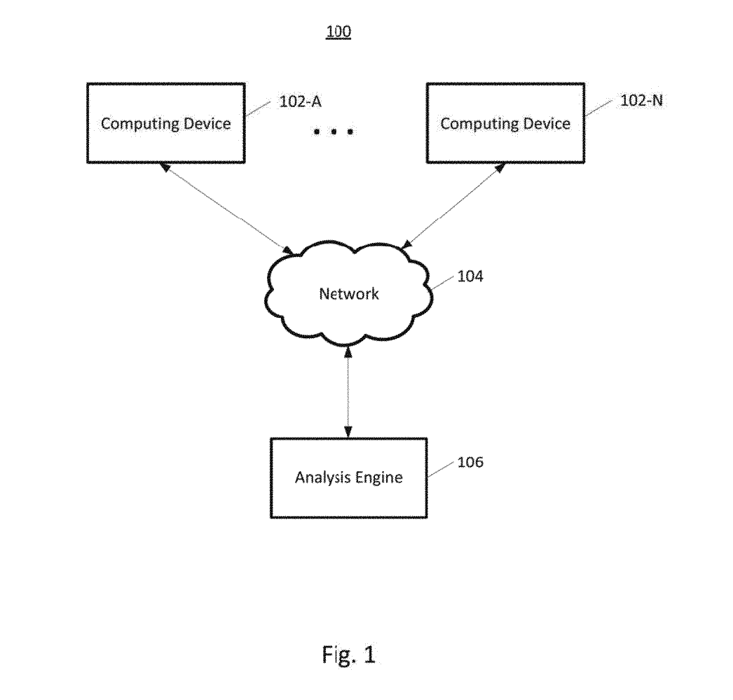

FIG. 1 shows a high-level diagram of a communications system 100, in accordance with one or more embodiments. Communications system 100 includes computing devices 102-A, . . . , 102-N (collectively referred to as computing devices 102). Computing devices 102 may comprise any type of computing device, such as, e.g., a computer, a tablet, or a mobile device. Computing devices 102 are operated by end users for communicating via network 104. Network 104 may include any type of network or combinations of different types of networks, and may be implemented in a wired and/or a wireless configuration. For example, network 104 may include one or more of the Internet, an intranet, a local area network (LAN), a wide area network (WAN), a Fibre Channel storage area network (SAN), a cellular communications network, etc.

End users of computing devices 102 may communicate via network 104 for interacting with an analysis engine 106 for the analysis of data. End users may interact with analysis engine 106 via an interface of a web browser executing on computing device 102, an application executing on computing device 102, an app executing on computing device 102, or any other suitable interface for interacting with analyzer engine 106. In one example, end users of computing devices 102 may interact with a software as a service (SaaS) application hosted by analysis engine 106 for the analysis of data. Analysis engine 106 may be configured to provide any type of data analysis.

Advantageously, embodiments of the present invention provide for an analysis engine 106, which facilitates the performance of complex data analysis tasks and generates a user interface (e.g., a graphical user interface) for clearly presenting the results of the data analysis to the end user. In particular, the results of the data analysis associated with a particular period of time may be presented as being apportioned or allocated to other prior or future periods of time in a stair step configuration. Such a stair step configuration quickly communicates the results of the data analysis and how the results are allocated over time. Analysis engine 106 in accordance with embodiments of the invention thus provides for improvements in computer related technology by facilitating the presentation of complex results of the data analysis to an end user to allow the end user to quickly and clearly interpret the results and identify how they are allocated over time.

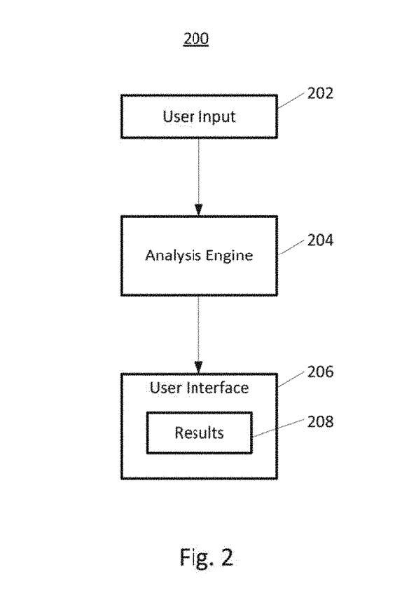

FIG. 2 shows a system 200 for the presentation of results of data analysis, in accordance with one or more embodiments. System 200 includes an analysis engine 204. In one embodiment, analysis engine 204 is analysis engine 106 of FIG. 1.

Analysis engine 204 receives user input 202. In one embodiment, user input 202 may be received from an end user, e.g., using computing device 102 of FIG. 1. In another embodiment, user input 202 is previously stored in a database (not shown) and retrieved by analysis engine 204. User input 202 includes data used for performing the analysis by analysis engine 204. For example, the data may include data to be analyzed by analysis engine 204. In another example, the data may include a scenario defining parameters for performing the analysis by, e.g., defining a particular entity and a particular time period for which the analysis is to be performed.

Analysis engine 204 may include any system for performing data analysis. In one embodiment, analysis engine 204 is the analysis engine disclosed in U.S. patent application Ser. No. 15/223,843, entitled “Data Analysis Engine,” which is herein incorporated by reference in its entirety. In particular, analysis engine 204 may perform the data analysis based on a definitions file defining variables and a calculations file defining parameters referencing the variables. In this manner, the data analysis performed by analysis engine 204 can be updated by updating a definitions file and/or a calculations file. Such an analysis engine 204 is advantageous in that, while analysis engine 204 may be implemented by a programmer, the definitions file and the calculations file may be updated and maintained by a non-programmer, without requiring the specialized skills of a programmer.

Analysis engine 204 performs analysis using user input 202 to generate results 208. Analysis engine 204 may perform any type of analysis. In one embodiment, analysis engine 204 analyzes user input 202 in accordance with methods known in the art. Results 208 may include a value of a variable, allocated amounts of the value of the variable, and utilized amounts of the variable. The value of the variable may be associated with (e.g., incurred in) a particular period of time (e.g., months, quarters, years, etc.) that is to be allocated over other periods of time (e.g., past and/or future periods). The variable may include, for example, a debt or a credit. Each of the allocated amounts represents an amount allocated from the value and associated with (e.g., applied to) one of the other periods of time. Each of the utilized amounts represents an amount of the variable associated with (e.g., utilized in) one of the other periods of time. In one embodiment, an allocated amount and a utilized amount correspond to each other when they are associated with a same period of time.

Analysis engine 204 generates user interface 206 (e.g., a graphical user interface) for presenting results 208. In one embodiment, analysis engine 204 causes user interface 206 to be displayed on a display device for the presentation of results 208. For example, the display device may be a display device of analysis engine 204 or a display device of computing device 102 of FIG. 1. Results 208 may be exported and reported as needed (e.g., in response to a user request, at periodic time intervals, etc.)

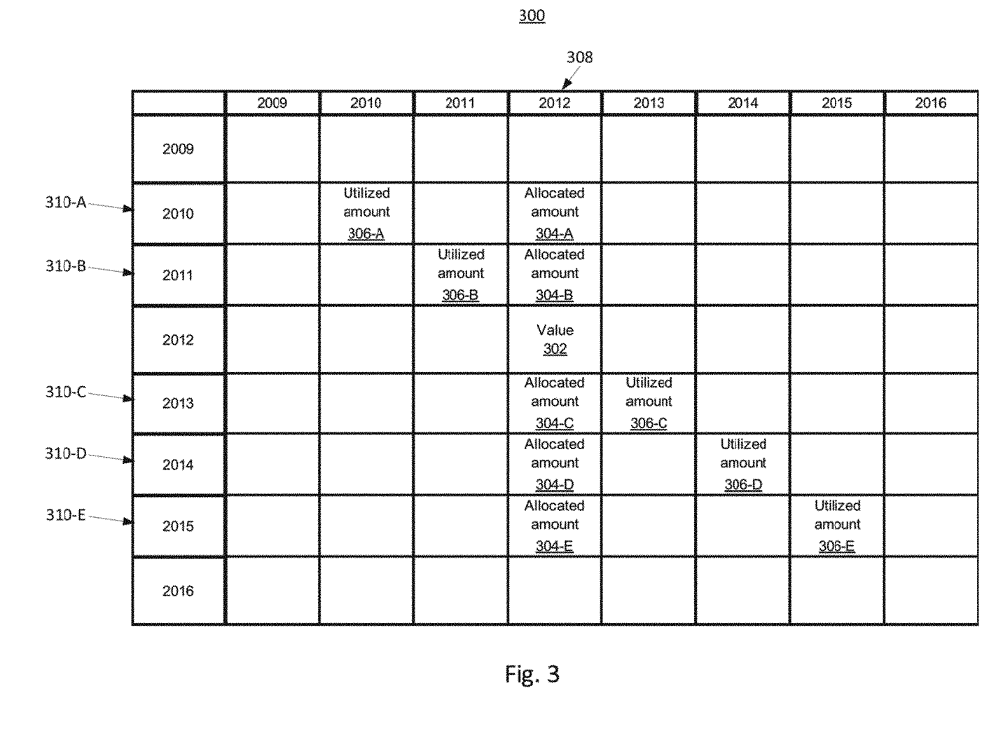

FIG. 3 illustratively depicts an exemplary presentation of results 300 of data analysis as presented on a user interface, in accordance with one embodiment. Results 300 may be results 208 presented on user interface 206 of FIG. 2. Results 300 are formatted in a spreadsheet or table in FIG. 3. While results 300 are presented for each of year 2009 through 2016, it should be understood that results 300 may be for any period of time, such as, e.g., seconds, minutes, days, months, quarters (of a year), or decades.

Results 300 include a value 302 associated with (e.g., incurred in) a particular period of time (i.e., the year 2012). Value 302 may represent any value of a variable that can be allocated to other periods of time. For example, value 302 may represent a value of a debt, a value of a credit, etc. Value 302 is allocated into allocated amounts 304-A, 304-B, 304-C, 304-D, and 304-E (collectively referred to as allocated amounts 304). For example, in one embodiment, value 302 is allocated into allocated amounts 304 and associated with (e.g., applied to) one of the other periods of time (i.e., years 2010-2011 and 2013-2015).

Each allocated amount 304 is represented in a cell associated with a column 308 corresponding to the period of time that value 302 is associated with (i.e., the year 2012 in FIG. 3) and with a respective row 310-A, 310-B, 310-C, 310-D, and 310-E corresponding to the period of time to which allocated amounts 304 are allocated. In FIG. 3, allocated amounts 304-A and 304-B are allocated back in time to years 2010 and 2011, respectively, and allocated amounts 304-C, 304-D, and 304-E are allocated forwards in time to years 2013, 2014, and 2015, respectively.

Utilized amounts 306-A, 306-B, 306-C, 306-D, and 306-E (collectively referred to as utilized amounts 306) represent an amount of the variable that is utilized for each of the other periods of time (i.e., years 2010-2011 and 2013-2015). Each utilized amount 306 is represented in a cell associated with a row and a column both corresponding to the period of time in which utilized amount 306 is utilized. Since both the row and the column associated with each utilized amount 306 refer to the same period of time, utilized amounts 306 are shown diagonally in the table from value 302. In this manner, utilized amounts 306 are presented in a stair step configuration.

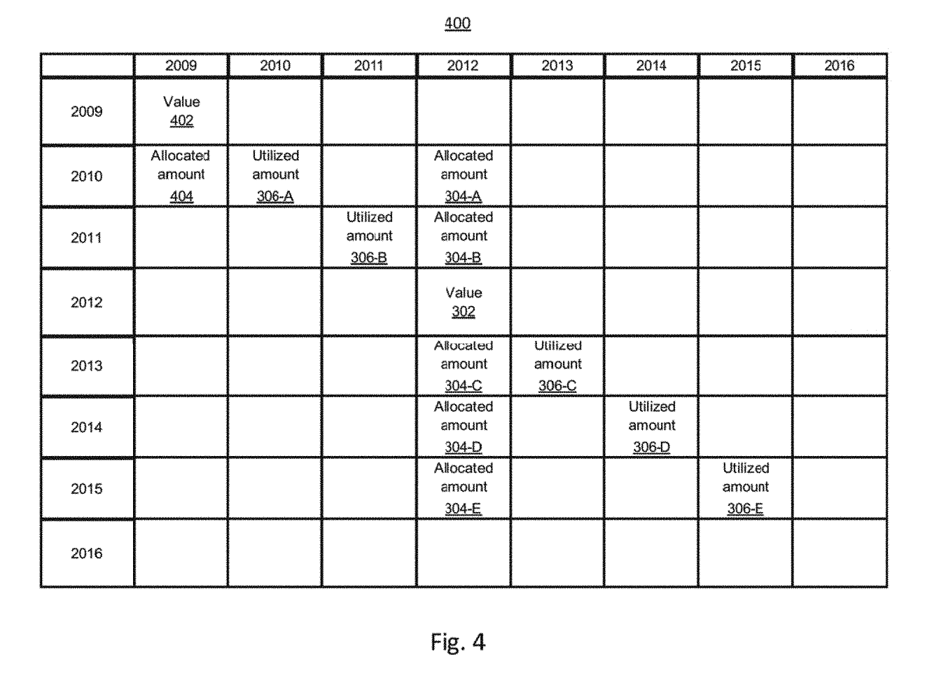

In one embodiment, utilized amounts 306 may be the same as their corresponding allocated amounts 304. For example, in FIG. 3, utilized amounts 306 would be the same as their corresponding allocated amounts 304 since there are no other values of the variable incurred in other years. However, in other embodiments, one or more of utilized amounts 306 may be different from their corresponding allocated amounts 304, such as, e.g., when there is an additional value of the variable incurred in other years, as shown in FIG. 4 discussed below.

Results 300 are presented having both rows and columns corresponding to periods of time to present utilized amounts 306 in a stair step configuration. Cells in the stair step configuration above value 302 show carryback utilization for prior years and cells in the stair step configuration below value 302 show carryforward utilization for years following the loss. Advantageously, the presentation of results 300 in this manner quickly communicates value 302 of a variable generated for the year 2012, how value 302 is allocated over time into allocated amounts 304, and how the variable is utilized over time as utilized amounts 306. Results 300 presented as shown in FIG. 3 facilitates the forecasting of any remaining portion of the variable in future years.

While the table in results 300 is described herein as having value 302, allocated amounts 304, and utilized amounts 306 presented in cells each associated with a particular row and column, one of ordinary skill in the art would understand that the table may be transposed (or rotated) to switch the rows to the columns and vice versa. For example, in one embodiment, allocated amounts 304 may be represented in a cell associated with a row corresponding to the period of time that value 302 is associated with (i.e., the year 2012 in FIG. 3) and with a respective column corresponding to the period of time to which allocated amounts 304 are allocated.

FIG. 4 illustratively depicts an exemplary presentation of results 400 of data analysis as presented on a user interface, in accordance with one embodiment. Results 400 include a value 302 of a variable incurred in 2012 and allocated over time to allocated amounts 304, as shown in FIG. 3. However, results 400 also include an additional value 402 of the variable incurred in 2009 and allocated to allocated amount 404. Since allocated amount 304-A and allocated amount 404 are both allocated to year 2010, utilized amount 306-A, representing the amount of the variable utilized in the year 2010, is the sum of allocated amount 304-A and allocated amount 404.

In one embodiment, analysis engine 204 of FIG. 2 is configured as a tax analysis engine for the computation of tax data and the presentation of tax results.

Traditional tax software has been unable to successfully automate the calculation and tracking of the net operating loss for all states in the United States across multiple years. Conventionally, the calculation and tracking of net operating losses across multiple years has been performed using spreadsheets or databases, which have poor controls, require large annual updates for tax law changes, and are often inaccurate.

In accordance with one or more embodiments of the invention, analysis engine 204 may be configured as a tax analysis engine to analyze tax data to generate tax results and present the tax results in a manner that quickly communicates the tax results to the user. In one example, the tax analysis engine may analyze tax data to calculate a net operating loss. A net operating loss occurs when tax deductible expenses exceed taxable income over a taxable period of time. Depending on the laws of the jurisdiction, a net operating loss may be allocated to certain prior years and future years to reduce taxable income in those years.

The tax analysis engine receives a user input, which may include tax information. The user input may also include data defining a scenario for the calculation of net operating loss. For example, the scenario may define an entity (e.g., a corporation) or group of entities (e.g., group of related corporations), a state, and a period of time for which the net operating loss is to be calculated. The tax analysis engine uses the user input to generate tax results. In one embodiment, the tax results may comprise a value of net operating loss associated with (e.g., incurred in) a particular period of time, allocated amounts of the value of the net operating loss associated with (e.g., applied to) other periods of time, and utilized amounts of the net operating loss associated with (e.g., utilized in) the other periods of time. The tax analysis system may also be configured to compute a loss generated for a given period of time, apply rules to adjust that loss to determine the net operating loss, and display the utilization of the net operating loss. The tax analysis engine determines the utilization of the net operating loss according to, e.g., state rules, such as the number of years permitted to carry back and carry forward, suspension years (where that year's income is not permitted to be offset by a loss), 26 U.S.C. 382 limitations, separate return limitation year (SRLY) limitations, etc.

The tax analysis engine may be configured to perform any suitable analysis to generate tax results. As discussed above, in one embodiment, the tax analysis engine may be the analysis engine disclosed in U.S. patent application Ser. No. 15/223,843, entitled “Data Analysis Engine,” to provide tax results based on a definitions file defining tax variables and a calculations file defining tax parameters referencing the variables.

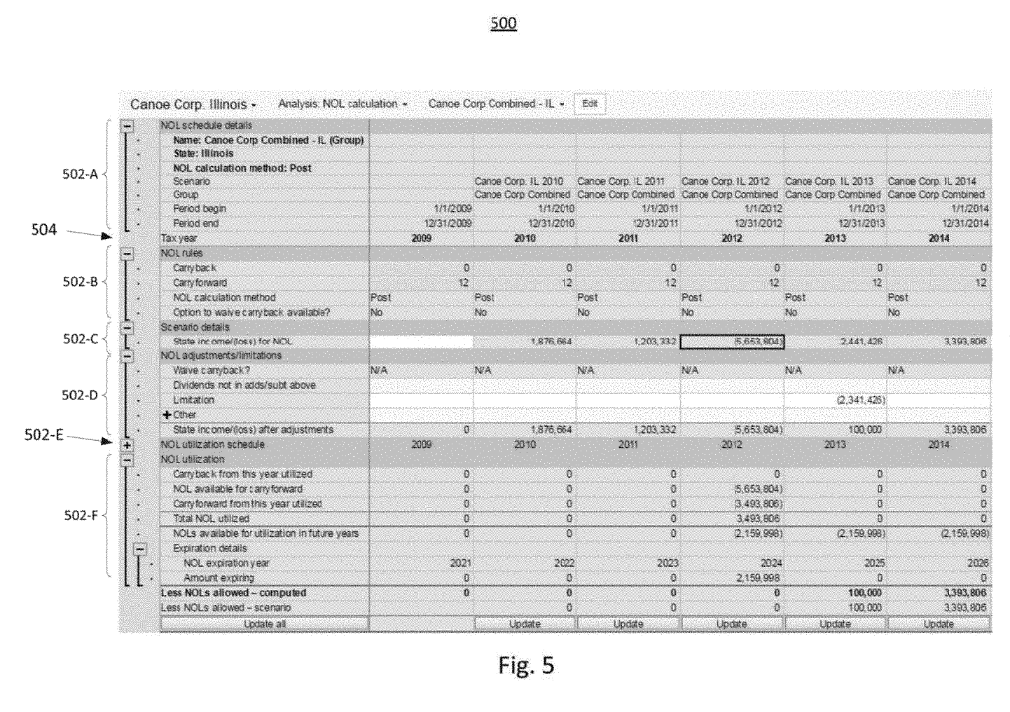

FIG. 5 illustratively depicts an exemplary presentation of tax results 500 of data analysis for the calculation and tracking of net operating loss as presented on a user interface, in accordance with one embodiment. Tax results 500 may be results 208 presented on user interface 206 of FIG. 2. Tax results 500 include sections 502-A, 502-B, 502-C, 502-E, and 502-F (collectively referred to as sections 502). Each of the sections 502 may be expanded or collapsed by a user interacting with the user interface.

Section 502-A, NOL schedule details, indicates parameters of the analysis performed by the tax analysis engine. The parameters may include, for example, the NOL schedule name (e.g., as assigned by a user), the state, the NOL calculation method (the method for determining the generated income or loss for a tax year), the scenario name (e.g., shown for scenarios that are part of a scenario family), the group or entity (e.g., as per state rules), and the periods of time for which the analysis is performed (e.g., the period begin and period end date, as defined by the scenario). The periods of time are identified in row 504 as the years for which the taxpayer is filing a return.

Section 502-B, NOL rules, comprises rules for the computation and tracking of the net operating loss. The tax engine (e.g., engine 204) may perform the analysis based on the rules defined in section 502-B. The rules in section 502-B may define, for example, the number of years a net operating loss may be carried back or carried forward, the calculation method of the net operating loss (e.g., pre-apportionment or post-apportionment), and whether there is an option to waive the carryback of the net operating loss. In one embodiment, end users may define the rules in section 502-B as needed for special situations or to analyze the impact of proposed tax law changes that have not yet become law.

Section 502-C, Scenario details, shows the generated state income or loss for each period of time identified in row 504. The generated state income or loss is adjusted, e.g., according to state laws and rules for the calculation of net operating loss. For example, some states follow pre-apportionment rules while other states follow post-apportionment rules, which impact the calculation of the generated income or loss in each period of time.

Section 502-D, NOL adjustments/limitations, comprises adjustments or limitations of the generated state income or loss due to various tax rules or impact from entity ownership (e.g., 26 U.S.C. 382 limitations or separate return limitation year (SRLY) limitations). In one embodiment, end users (e.g., a NOL manager) may define the tax rules, limitations, additions, adjustments, etc. in this section for modifying the computation and tracking of net operating loss. Section 502-D may provide an option to waive carryback (if permitted by the state), dividends and limitations (as input by a user), miscellaneous state adjustments (e.g., automatic limitations, adjustments, etc. applied based on state laws), and the state income or loss after adjustments.

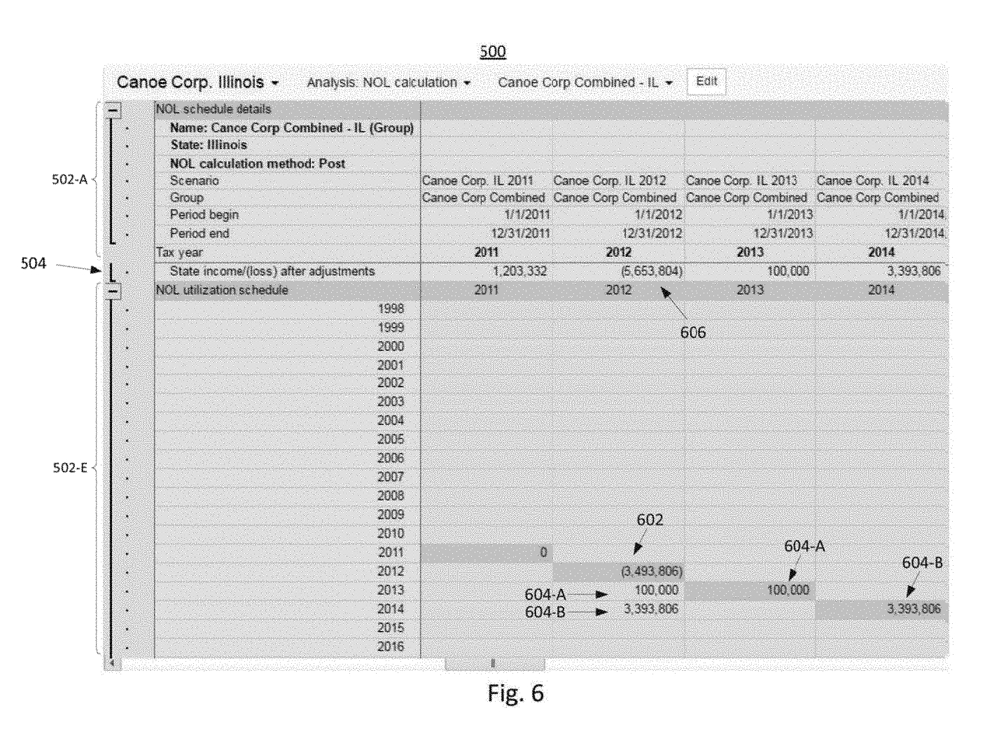

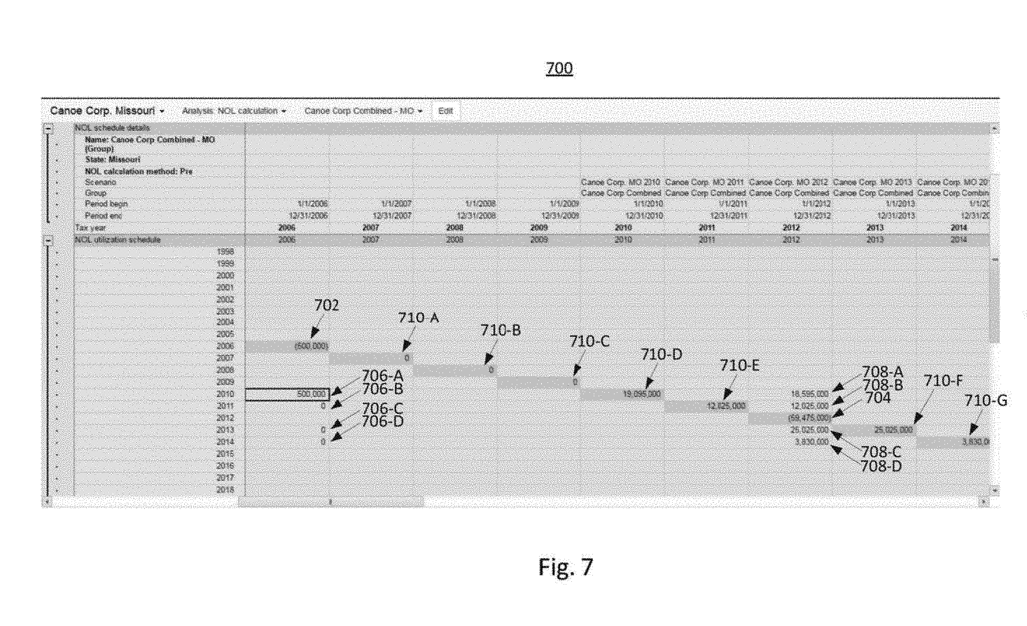

Section 502-E, NOL utilization schedule, provides a utilization schedule summarizing the utilization of the net operating loss. In one embodiment, section 502-E shows how the income generated in section 502-C is offset by losses generated in section 502-C for prior or future periods of time. The loss may be allocated based on first in, first out rules, last in, first out rules, or any other suitable approach. Section 502-E is shown collapsed in FIG. 5, however details of section 502-E will be discussed in further detail below with reference to FIG. 6 and FIG. 7.

Section 502-F, NOL utilization, comprises details of how the calculated net operating loss is utilized over the periods of time. For example, section 502-F indicates, for each period of time, the utilized carryback, the net operating loss available for carryforward, the utilized carryforward, the total net operating loss utilized, the net operating loss available for utilization in future years, and the amount and year of expiration of any remaining net operating loss.

FIG. 6 illustratively depicts an exemplary utilization schedule of tax results 500 shown in FIG. 5, in accordance with one embodiment. The utilization schedule shown in section 502-E of FIG. 6 may be the utilization schedule in section 502-E of FIG. 5 when expanded.

Results 500 show a loss 606 of $5,653,804 in year 2012. Of this $5,653,804 loss, a value 602 of $3,493,806 is utilized to offset income in the years 2013 and 2014. The remaining amount of the loss, $2,159,998, is not utilized as there is not enough income in future years to offset this loss and carryback is not permitted in this example. The unutilized loss is shown in section 502-F in FIG. 5 with an expiration year of 2024. Value 602 of the net operating loss is identified in the utilized schedule as a negative number in its respective year it was incurred using parentheses, however the net operating loss may be identified using any identifier (e.g., a negative sign, colors, or textual styling).

The $3,493,806 loss is allocated into allocated amount 604-A in 2013 and allocated amount 604-B in 2014. In accordance with applicable laws and regulations, the net operating loss that can be utilized in a year is limited by state taxable income. Thus, allocated amount 604-A in 2013 is $100,000 and the remaining amount of the net operating loss, $3,393,806, is fully utilized in 2014 as allocated amount 604-B. The representation of the net operating loss utilization schedule having rows and columns both associated with periods of time allows for the presentation of results in a stair step configuration, to thereby represent very complex information in a simpler format to support decision making in, e.g., tax compliance and planning work.

FIG. 7 illustratively depicts an exemplary net operating loss utilization schedule 700, in accordance with one embodiment. Utilization schedule 700 may be the utilization schedule in section 502-E of FIG. 5.

Utilization schedule 700 comprises a value of a net operating loss 702 of $500,000 incurred in 2006 and a value of a net operating loss 704 of $59,475,000 incurred in 2012. Net operating loss 702 is allocated into allocated amounts 706-A, 706-B, 706-C, and 706-D (collectively referred to as allocated amounts 706). Allocated amounts 706 are allocated to years having taxable income, starting from an earliest permitted date to a latest permitted date (e.g., by law or by rules input by the end user) until net operating loss 702 is fully utilized. Net operating loss 702 is fully utilized in allocated amount 706-A. While net operating loss 702 is allocated into allocated amounts 707 according to first in, first out ordering rules in FIG. 7, it should be understood that net operating loss 702 may be allocated according to any suitable ordering rule, such as, e.g., last in, first out.

Net operating loss 704 is allocated into allocated amounts 708-A, 708-B, 708-C, and 708-D (collectively referred to as allocated amounts 708). Allocated amounts 708 are allocated to periods of time (e.g., years) having taxable income, starting from an earliest permitted date to a latest permitted date (e.g., by law) until net operating loss 704 is fully utilized.

Utilized amounts 710-A, 710-B, 710-C, 710-D, 710-E, 710-F, and 710-G (collectively referred to as utilized amounts 710) represent amounts of the net operating loss that are utilized. According to applicable laws and regulations, net operating loss is utilized in years where there is taxable income. As such, the first year where a net operating loss is utilized is in year 2010 with a utilized amount 710-D of $19,095,000. Utilized amount 710-D is the sum of allocated amount 706-A allocated from net operating loss 702 incurred in 2006 and allocated amount 708-A allocated from net operation loss 704 incurred in 2012. Since net operating loss 702 was fully utilized in 2010 and there are no other net operating losses incurred (aside from net operating loss 704), the remaining utilized amounts 710 are the same as their corresponding allocated amounts 708 of net operating loss 704.

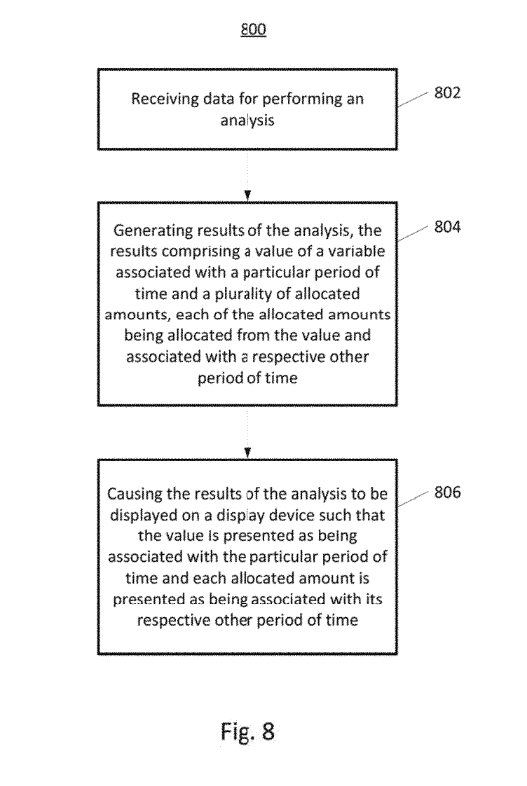

FIG. 8 shows a flow diagram of a method 800 of operation of the analysis engine 202, in accordance with one or more embodiments.

At step 802, data for performing an analysis is received from a user. The received data may include data to be analyzed, such as, e.g., tax return information. The received data may also include data defining boundaries for performing the analysis, such as, e.g., an entity or group of entities, one or more states, and a period of time for which tax results are to be determined.

At step 804, results of the analysis are generated. The results may include a value of a variable associated with (e.g., incurred in) a particular period of time. In one embodiment, the variable is a tax variable such as, e.g., a net operating loss. The results may also include allocated amounts, each allocated from the value of the net operating loss and associated with (e.g., applied to) a respective other period of time. The allocated amounts may be allocated back in time and/or forwards in time. The results may further include utilized amounts of the net operating loss each associated with (e.g., utilized in) a respective other period of time. Each utilized amount is a sum of all allocated amounts that are associated with a same period of time as the respective utilized amount (i.e., sum of all allocated amounts that are associated respective other periods of time that is the same as the respective other period of time of the utilized amount).

At step 806, the results of the analysis are caused to be displayed on a display device such that the value is presented as being associated with the particular period of time and each allocated amount is presented as being associated with its respective other periods of time. In one embodiment, the results of the analysis are displayed on a table (or spreadsheet) having rows and columns both corresponding to time.

The table displays the value of the net operating loss, the allocated amounts of the net operating loss, and the utilized amounts of the net operating loss. In particular, the value of the net operating loss is presented in a cell of the table that is associated with a row and a column both corresponding to the particular period of time. Each of the allocated amounts is presented in a respective cell of the table that is associated with a row corresponding to its respective other period of time and a column corresponding to the particular period of time. Each of the utilized amounts is presented in a respective cell associated with a row and a column both corresponding to its respective other period of time. In this manner, the utilized amounts are presented in a stair step configuration to facilitate the presentation of complex results in a simple, easy to understand manner.

One of ordinary skill in the art would understand that the table may be transposed (or rotated) to switch the rows to the columns and vice versa.

Systems, apparatuses, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be implemented within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIG. 8. Certain steps of the methods described herein, including one or more of the steps of FIG. 8, may be performed by a server or by another processor in a network-based cloud-computing system. Certain steps of the methods described herein, including one or more of the steps of FIG. 8, may be performed by a client computer in a network-based cloud computing system. The steps of the methods described herein, including one or more of the steps of FIG. 8, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 8, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

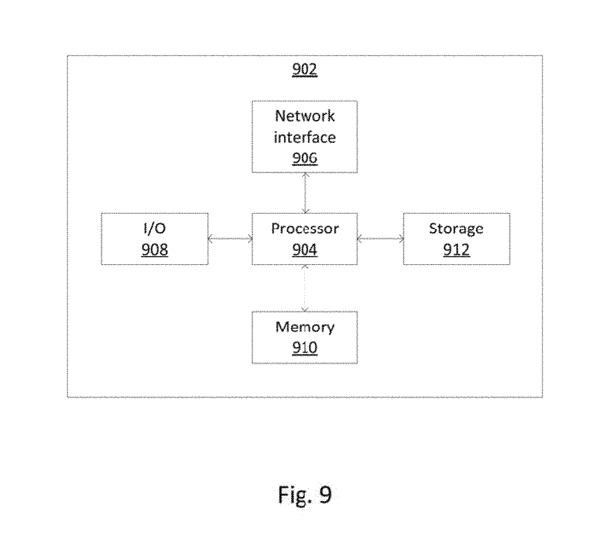

A high-level block diagram 900 of an example computer that may be used to implement systems, apparatus, and methods described herein is depicted in FIG. 9. Computer 902 includes a processor 904 operatively coupled to a data storage device 912 and a memory 910. Processor 904 controls the overall operation of computer 902 by executing computer program instructions that define such operations. The computer program instructions may be stored in data storage device 912, or other computer readable medium, and loaded into memory 910 when execution of the computer program instructions is desired. Thus, the method steps of FIG. 8 can be defined by the computer program instructions stored in memory 910 and/or data storage device 912 and controlled by processor 904 executing the computer program instructions. For example, the computer program instructions can be implemented as computer executable code programmed by one skilled in the art to perform the method steps of FIG. 8. Accordingly, by executing the computer program instructions, the processor 904 executes the method steps of FIG. 8. Computer 902 may also include one or more network interfaces 906 for communicating with other devices via a network. Computer 902 may also include one or more input/output devices 908 that enable user interaction with computer 902 (e.g., display, keyboard, mouse, speakers, buttons, etc.).

Processor 904 may include both general and special purpose microprocessors, and may be the sole processor or one of multiple processors of computer 902. Processor 904 may include one or more central processing units (CPUs), for example. Processor 904, data storage device 912, and/or memory 910 may include, be supplemented by, or incorporated in, one or more application-specific integrated circuits (ASICs) and/or one or more field programmable gate arrays (FPGAs).

Data storage device 912 and memory 910 each include a tangible non-transitory computer readable storage medium. Data storage device 912, and memory 910, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 908 may include peripherals, such as a printer, scanner, display screen, etc. For example, input/output devices 908 may include a display device such as a cathode ray tube (CRT) or liquid crystal display (LCD) monitor for displaying information to the user, a keyboard, and a pointing device such as a mouse or a trackball by which the user can provide input to computer 902.

Any or all of the systems and apparatus discussed herein, including computing devices 102 and analysis engine 106 of FIG. 1 and analysis engine 204 of FIG. 2, may be implemented using one or more computers such as computer 902.

One skilled in the art will recognize that an implementation of an actual computer or computer system may have other structures and may contain other components as well, and that FIG. 9 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
generating results of an analysis, the results comprising a value of a variable associated with a particular period of time and a plurality of allocated amounts, each of the allocated amounts being allocated from the value and associated with a respective other period of time; and
causing the results of the analysis to be displayed on a display device such that the value is presented as being associated with the particular period of time and each allocated amount is presented as being associated with its respective other period of time.

2. The method of claim 1, wherein the allocated amounts are allocated back in time and forwards in time.

3. The method of claim 1, wherein causing the results of the analysis to be displayed on the display device comprises:
causing the results to be displayed on a table having rows and columns corresponding to periods of time by causing the value to be displayed in a cell of the table associated with a row and a column corresponding to the particular period of time.

4. The method of claim 3, wherein causing the results to be displayed on the table comprises:
causing each of the allocated amounts to be displayed in a respective cell of the table associated with a row corresponding to its respective other period of time and a column corresponding to the particular period of time.

5. The method of claim 3, wherein causing the results to be displayed on the table comprises:
causing each of the allocated amounts to be displayed in a respective cell of the table associated with a column corresponding to its respective other period of time and a row corresponding to the particular period of time.

6. The method of claim 3, wherein the results further comprise utilized amounts of the variable each associated with a respective other period of time.

7. The method of claim 6, wherein each respective utilized amount is a sum of all allocated amounts that are associated with a same period of time as the respective utilized amount.

8. The method of claim 6, wherein causing the results to be displayed on the table comprises:
causing each of the utilized amounts to be presented in a respective cell of the table associated with a row and a column corresponding to its respective other period of time.

9. The method of claim 1, wherein the variable comprises a tax variable.

10. The method of claim 9, wherein the tax variable comprises a net operating loss.

11. A computer readable medium storing computer program instructions, which, when executed on a processor, cause the processor to perform operations comprising:
generating results of an analysis, the results comprising a value of a variable associated with a particular period of time and a plurality of allocated amounts, each of the allocated amounts being allocated from the value and associated with a respective other period of time; and
causing the results of the analysis to be displayed on a display device such that the value is presented as being associated with the particular period of time and each allocated amount is presented as being associated with its respective other period of time.

12. The computer readable medium of claim 11, wherein causing the results of the analysis to be displayed on the display device comprises:
causing the results to be displayed on a table having rows and columns corresponding to periods of time by causing the value to be displayed in a cell of the table associated with a row and a column corresponding to the particular period of time.

13. The computer readable medium of claim 12, wherein causing the results to be displayed on the table comprises:
causing each of the allocated amounts to be displayed in a respective cell of the table associated with a row corresponding to its respective other period of time and a column corresponding to the particular period of time.

14. The computer readable medium of claim 12, wherein causing the results to be displayed on the table comprises:
causing each of the allocated amounts to be displayed in a respective cell of the table associated with a column corresponding to its respective other period of time and a row corresponding to the particular period of time.

15. The computer readable medium of claim 12, wherein the results further comprise utilized amounts of the variable each associated with a respective other period of time.

16. The computer readable medium of claim 15, wherein each respective utilized amount is a sum of all allocated amounts that are associated with a same period of time as the respective utilized amount.

17. The computer readable medium of claim 15, wherein causing the results to be displayed on the table comprises:
causing each of the utilized amounts to be presented in a respective cell of the table associated with a row and a column corresponding to its respective other period of time.

18. The computer readable medium of claim 11, wherein the variable comprises a net operating loss.

19. A method comprising:
generating results of an analysis, the results comprising:
a first value of a variable associated with a first period of time,
a second value of the variable associated with a second period of time,
a plurality of first allocated amounts each allocated from the first value and associated with a respective other period of time,
a plurality of second allocated amounts each allocated from the second value and associated with a respective other period of time, and
a plurality of utilized amounts of the variable each associated with a respective other period of time;
generating a user interface for presenting the results by representing the first value as being associated with the first period of time, representing the second value as being associated with the second period of time, representing each of the first allocated amounts as being associated with its respective other period of time, representing each of the second allocated amounts as being associated with its respective other period of time, and representing each utilized amount as being associated with its respective other period of time; and
causing the user interface to be displayed on a display device.

20. The method of claim 19, wherein generating the user interface for presenting the results comprises:
representing the results on a table having rows and columns corresponding to periods of time such that the first value is represented in a cell of the table associated with a row and a column corresponding to the first period of time and the second value is represented in a cell of the table associated with a row and a column corresponding to the second period of time.

21. The method of claim 20, wherein generating the user interface for presenting the results comprises:
representing each of the first allocated amounts in a respective cell of the table associated with a row corresponding to its respective other period of time and a column corresponding to the first period of time; and
representing each of the second allocated amounts in a respective cell of the table associated with a row corresponding to its respective other period of time and a column corresponding to the second period of time.

22. The method of claim 20, wherein generating the user interface for presenting the results comprises:
representing each of the first allocated amounts in a respective cell of the table associated with a column corresponding to its respective other period of time and a row corresponding to the first period of time; and
representing each of the second allocated amounts in a respective cell of the table associated with a column corresponding to its respective other period of time and a row corresponding to the second period of time.

23. The method of claim 20, wherein generating the user interface for presenting the results comprises:
representing each of the utilized amounts in a respective cell of the table associated with a row and a column corresponding to its respective other period of time.
